(19) United States
(12) Patent Application Publication
(10) Pub. No.: US 2008/0008799 A1
(43) Pub. Date: Jan. 10, 2008

(54) Device and Method for Manufacturing Molded Food Articles

(75) Inventor: Bettina Zuger, Wil (CH)

Correspondence Address: HESLIN ROTHENBERG FARLEY & MESITI PC, 5 COLUMBIA CIRCLE, ALBANY, NY, 12203, US

(73) Assignee: Zuger Frischkase AG, Oberburen (CH)

(21) Appl. No.: 11/630,074

(22) PCT Filed: Jun. 16, 2005
(86) PCT No.: PCT/CH05/00338

§ 371 Date: Dec. 19, 2006

(30) Foreign Application Priority Data
Jun. 19, 2004 (DE) 10 2004 029 408.9

(51) Int. Cl. A23P 1/10; A22C 7/00; A23C 19/068

(52) U.S. Cl. 426/389; 99/453; 99/460; 99/464

(57) ABSTRACT

Disclosed is a device and method for manufacturing molded, viscoelastic food articles, in particular out of doughy, viscoelastic fresh cheese, such as mozzarella or mascarporie.

The invention relates to a device and a method for manufacturing molded, viscoelastic food articles, in particular out of doughy, viscoelastic fresh cheese, such as mozzarella or mascarpone, according to the preamble of claim 1, as well as the preamble of claim 15.

In such devices and methods, pressurized viscoelastic food masses, e.g., fresh cheese, are pressed into depressions (alveoli) in a moving wall, entrained in these depressions and separated from the remainder of the pressurized viscoelastic food mass. As a result, the viscoelastic food mass is simultaneously molded and portioned.

Given the viscoelasticity of such masses, expansions and compressions of the mass give rise to tensions in the separated and molded food portion, which after molded in the food article formed in this way generally result in deformations or so-called warpage. This warpage is less apparent and most often accepted in simple shapes, such as balls (mozzarella “balls”).

In other food molding areas, e.g., the chocolate industry, use is made of materials that can be influenced mainly by controlling a parameter, e.g., temperature, in such a way as to achieve sufficient dimensional stability almost immediately as the result of sufficiently intensive cooling, e.g., from about 30° C. to 40° C. down to about 0° C. to 10° C. The object of the invention is to obtain correctly molded food articles even while shaping and portioning viscoelastic foods, despite the virtually unavoidable warpage. This is especially desirable in symmetrically shaped food articles, since warpage or subsequent deformation becomes highly evident after the molding process.

This object is achieved by the device according to claim 1 and the method according to claim 15.

Portioning and molding takes place as follows according to the invention:

One portion of the initial mass is pressed into a respective depression, fills it out and is entrained by the latter.

The stripping or shearing of portions entrained in the depressions from the remaining initial mass volume in the pressing chamber takes place as the depressions filled with the initial mass portions pass by a sealing surface or contacting edge, which acts as a shearing edge or stripping edge.

The stripped or sheared portions of initial mass entrained in the depressions are then conveyed out of the pressing chamber.

The portions removed from the pressing chamber are then formed by discarding and/or ejecting the portions from the depressions into a temperature-controlled water bath, where the latter remain for a product-specific period of time.

According to the invention, the stripping edge or shearing edge is the edge of a stripping surface or shearing surface pointing into the pressing chamber, which borders the alveoli surface of the first inner wall area in a gusset region. In this case, the tangential plane E2 of the shearing surface forms a shearing angle or striping angle α with the tangential plane E1 of the alveoli surface in the gusset region measuring less than 90°. In addition, the inner dimensions and mold cavities of the first inner wall area defined by the depressions (alveoli) are enlarged by stretching factor S in the direction parallel to the direction of movement of the first inner wall area relative to the inner dimensions of the cavity complementary to the shape of the fresh cheese article to be manufactured.

The shearing angle preferably ranges from 50° to 80°, more preferably from 60° to 70°.

The stretching factor corresponding thereto preferably ranges from 1.05 to 1.5, and more preferably from 1.1 to 1.3.

The pressing chamber can preferably be temperature-controlled, wherein the movable first inner wall area of the pressing chamber can best be temperature-controlled by means of a heat carrier fluid, which is preferably water.

The temperature of the food material can be specifically controlled over time during its shaping by controlling the temperature of the movable inner wall area of the pressing chamber along its direction of movement with varying temperatures.

Further, it is advantageous for the pressing power or packing power that can be generated by the press to be adjustable, and/or for the driving means-generated speed at which the alveoli surface moves along the shearing edge be adjustable.

In a particularly preferred embodiment of the device according to the invention, the movable first inner wall area of the pressing chamber is a partial area of the cylinder jacket outer surface of a cylindrical blow molding, which is rotated around its cylindrical axis as the rotational axis, wherein the depressions (alveoli) acting as the mold are arranged in the cylinder jacket outer surface.

In this case, the pressing chamber or packing chamber is preferably a resting blow molding, which has an inlet opening fluidically connected with the press, as well as an outlet opening. The opening edge of the outlet opening is designed in such a way that the partial area of the cylinder jacket outer surface pressed against this blow molding outlet opening seals the blow molding outlet opening.

This embodiment is particularly well suited for a continuous method.

It is particularly advantageous if the depressions (alveoli) each be fluidically connected with the inner space of the cylindrical blow molding by means of a fluid channel that radially traverses the cylinder wall.

This design facilitates shaping during the continuous method.

Also advantageous in this embodiment is that the molded fresh cheese portions are shaped by exposing the molded fresh cheese portions sitting in the depressions of the cylinder jacket outer surface to gravitational and/or centrifugal forces.

Shaping can also be supported by a water jet and/or compressed air, e.g., which is directed into the depressions via the radial fluid channel, and acts on the molded fresh cheese portions sitting in the depressions.

The water jet and/or compressed air can be temperature-controlled. This measure makes it possible to support the shaping and dimensional stabilization process at the same time.

The method according to the invention is particularly well suited for shaping fresh cheese, wherein at least partially dimensionally stabilized viscoelastic fresh cheese articles (mozzarella, mascarpone) are obtained.

In this case, the temperature controlled fresh cheese has a temperature ranging from 60° C. to 70° C. as it penetrates into the depressions and exits the pressing chamber, while the temperature-controlled water bath has a temperature ranging from 5° C. to 20° C.

The temperature-controlled water bath preferably has a first water bath with a temperature ranging from 10° C. to 20° C., as well as a second water bath with a temperature ranging from 5° C. to 10° C., in which the shaped portions of the fresh cheese are allowed to remain sequentially.

The temperature-controlled fresh cheese preferably has a temperature ranging from 64° C. to 66° C. as it penetrates into the depressions and exits the pressing chamber.

These measures facilitate the dimensional stabilization of the molded fresh cheese articles.

The solution according to the invention hence applies to the problem of deformation. Already during the development and design of the molding tool (shape of cavity, depressions or alveoli), warpage must be factored into the equation, and the mold must be fabricated in such a way as to ameliorate the subsequent warpage behavior of the viscoelastic mass.

For purposes of dimensional stabilization during the shaping process, the shaping tool can be enhanced in such a way that high temperature differences can be regulated all around the individual molds, e.g., by means of heating and cooling elements integrated all around the individual mold in the tool.

The pasta-spun cheese mass is pressed into the individual molds (depressions, alveoli) . The symbol figure (molded food article) is removed from the individual mold via the rotational motion of the drum and a water or air jet emanating from inside the drum (hole in the individual mold). The dimensional stability is achieved by developing a suitable mold, and by shaping the warm cheese mass in cold water, or additionally via high temperature differences.

The invention uses a tool for shaping plastic figures subject to warpage instead of conventional spherical molds.

The measures taken in the process include the development of individual figures taking into account warpage for the respective figure, and an arrangement of these figures that enables a shaping of the numerous individual molds.

Other advantages, features and possible applications of the invention can be gleaned from the following description of various partial aspects and examples, which is not to be construed as limiting, however.

The figures show:

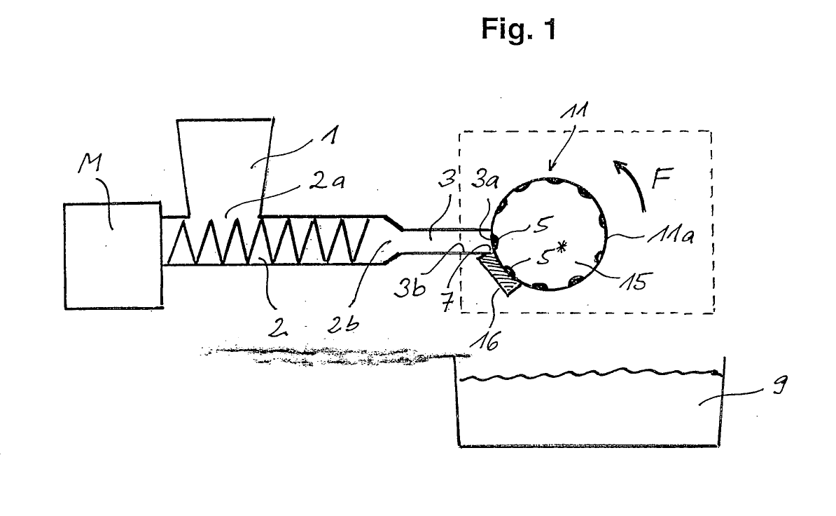

FIG. 1 a diagrammatic overall view of the device according to the invention;

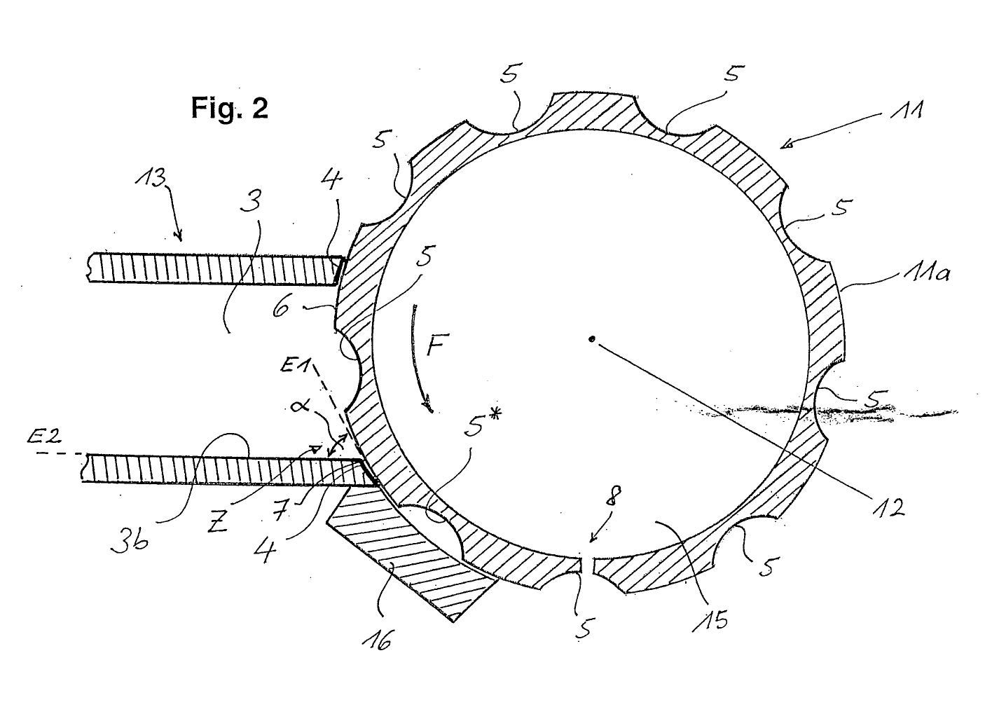

FIG. 2 a diagrammatic sectional view of the part framed on FIG. 1;

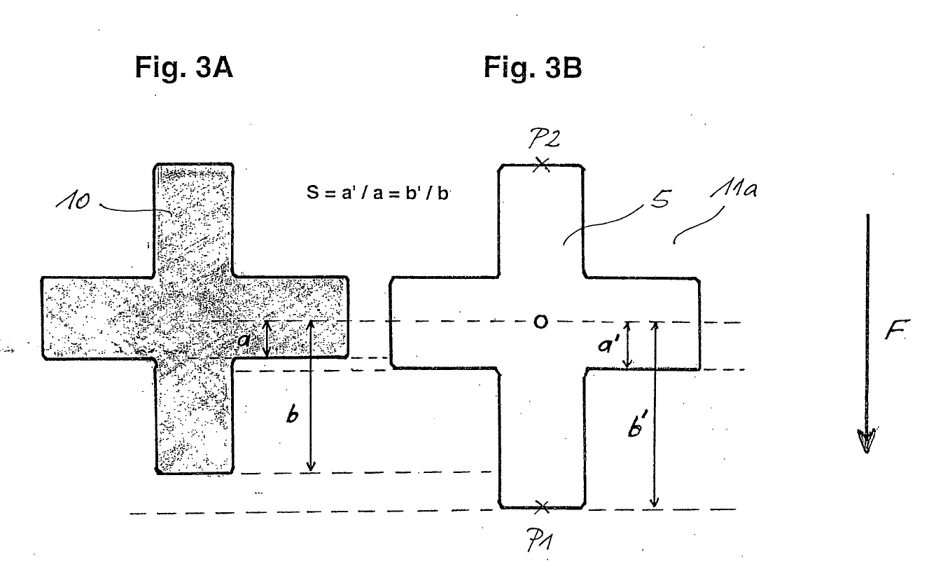

FIG. 3A a top view of a viscoelastic food article, and

FIG. 3B a top view of an alveolus according to the invention for manufacturing the food article shown on FIG. 3A as described in the invention;

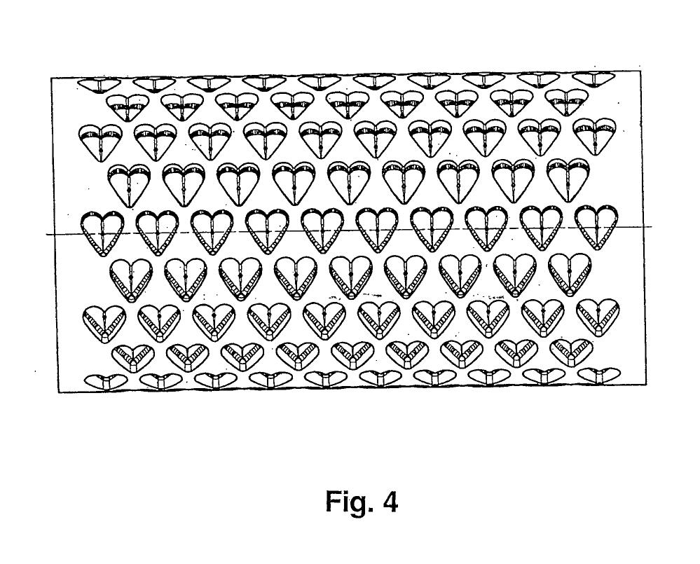

FIG. 4 a “Herzli” (heart) molding drum;

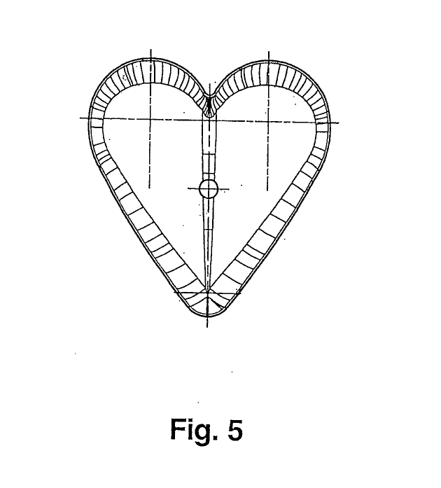

FIG. 5 the arrangement of individual “Herzli” molds, and the arrangement of fluid jet openings and heart mold with compensation for longitudinal warpage;

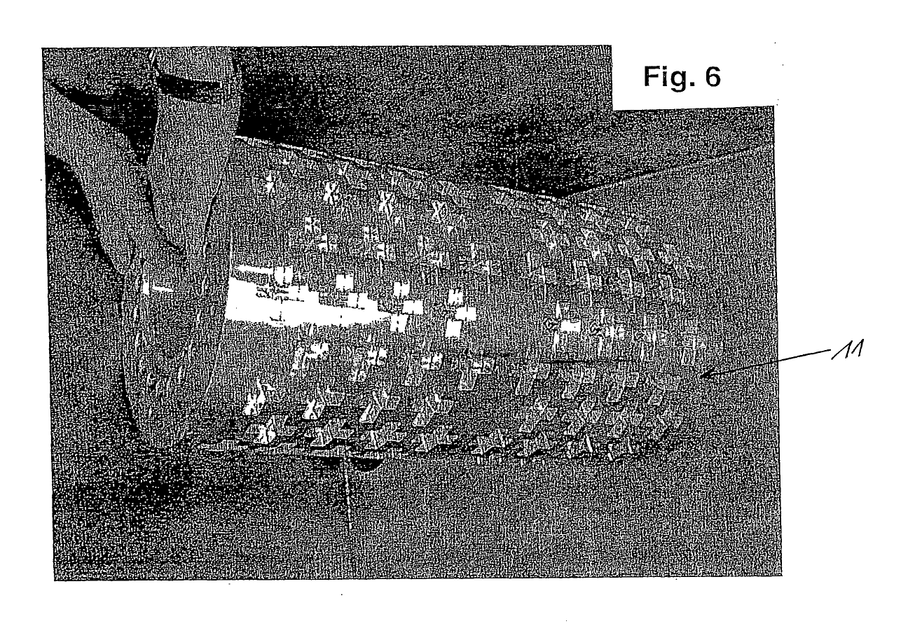

FIG. 6 a “Kreuzli” (cross) molding drum;

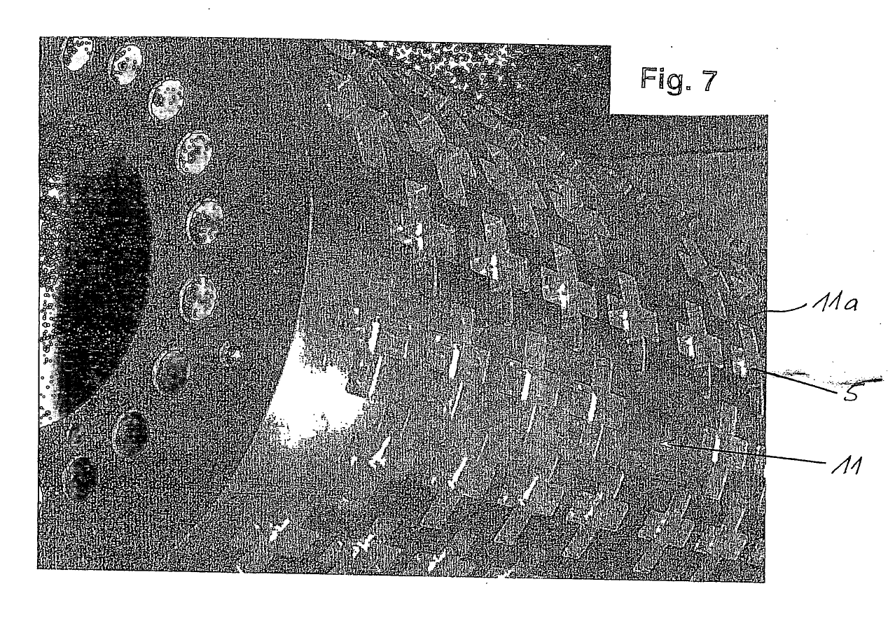

FIG. 7 the arrangement of the individual “Kreuzli” molds;

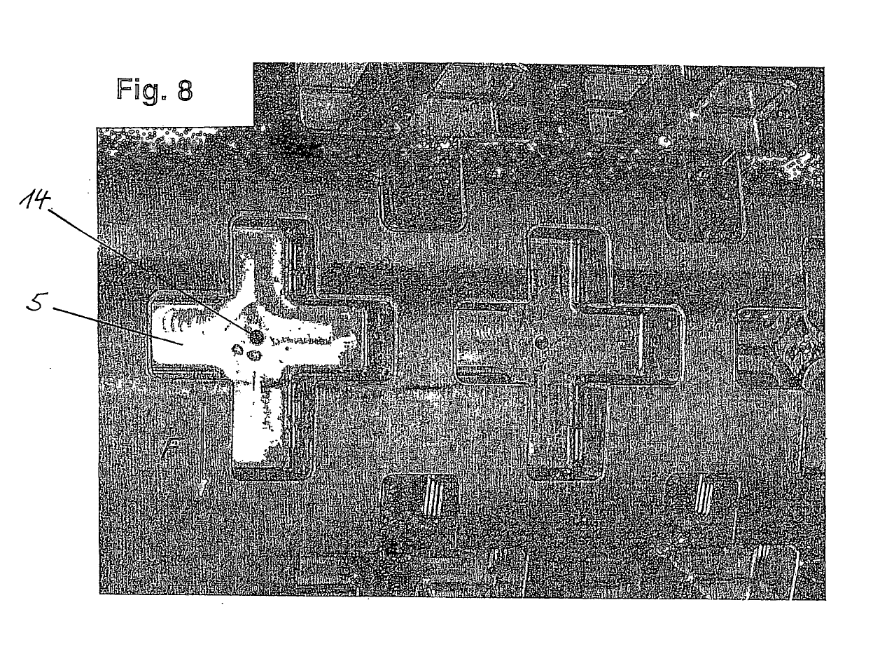

FIG. 8 the arrangement of individual “Kreuzli” molds, and the arrangement of fluid jet openings and cross mold with compensation for longitudinal warpage (including the warpage that arises in the shaping and storage process);

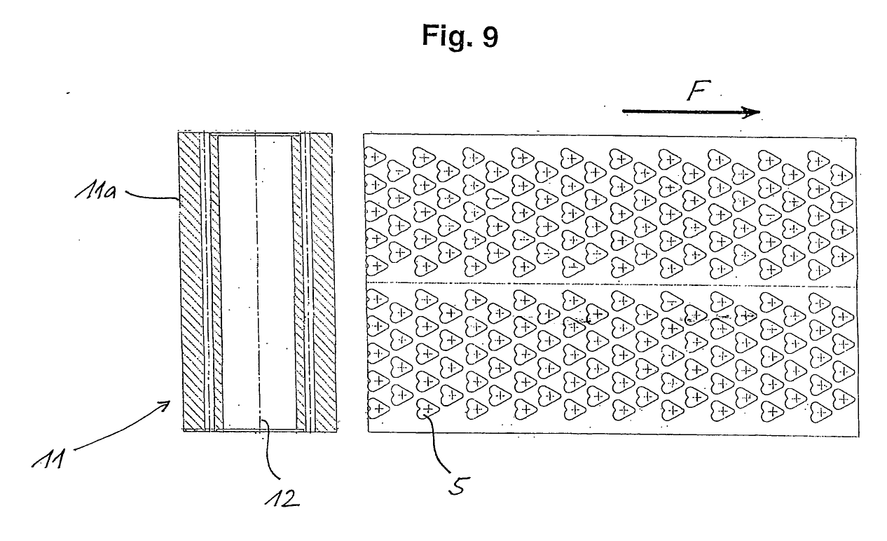

FIG. 9 a diagrammatic view of the development of the cylinder surface with alveoli according to FIG. 4; and

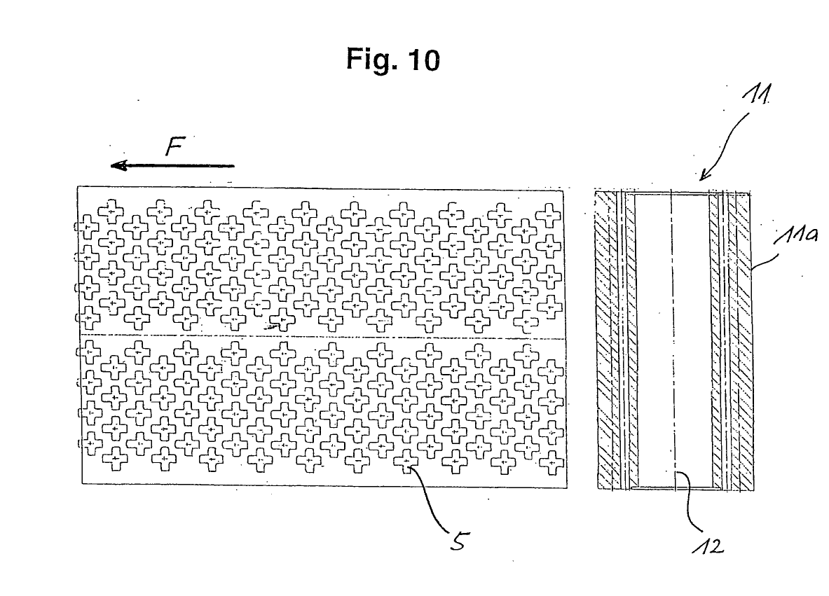

FIG. 10 a diagrammatic view of the development of the cylinder surface with alveoli according to FIG. 6.

### FIG. 1 shows a diagrammatic overall view of a particularly advantageous embodiment of the device according to the invention. FIG. 2 is a diagrammatic side view of the part framed on FIG. 1.

A supply tank 1 for fresh cheese is connected with the input 2a of a press 2. The press 2 is powered by a drive unit M, and used to build up pressure in the fresh cheese. The output 2b of the press 2 is connected with a pressing chamber 3, which is bordered by a first inner wall area 3a and a second inner wall area 3b. The first inner wall area 3a and the second inner wall area 3b border each other at a sealing surface 4 (see FIG. 2).

The first inner wall area 3a is a portion of the cylinder jacket outer surface lla of a cylindrical blow molding 11, which is rotationally driven around its cylinder axis 12 by driving means (not shown). The cylinder body 11 is driven in such a way that its cylinder jacket outer surface 11a moves in the circumferential direction denoted by the arrow F. The cylinder jacket outer surface 11a incorporates depressions 5, so-called alveoli (see also FIG. 2), which serve as the mold cavity

The inner space 15 of the hollow cylinder 11 can carry a heat carrier fluid, e.g., water, or the cylinder jacket inner surface 11b can be sprayed with this heat carrier fluid. For reasons of food hygiene, water is preferred as the heat carrier fluid. The hollow cylinder preferably consists of high-grade steel or aluminum alloy. Instead of the fluid-carrying inner space 15 or sprayed cylinder jacket inner surface 11b, the wall of the cylindrical blow molding 11 can also be interspersed by heat carrier fluid channels (not shown). This enables a very precise temperature control of the alveoli 5.

The first inner wall area 3a of the pressing chamber 3 is immediately followed along the motional or circumferential direction F of the hollow cylinder 11 by an additional pressing element 16 with a contact surface 16a bent to complement the cylinder jacket outer surface 11a. In conjunction with the alveoli 5 moved by this pressing element 16 in motional direction F, completely self-contained mold cavities 5* are defined. The pressing element 16 can also be temperature controlled. In this way, the moving mold cavities 5* (see FIG. 2) can be intensively temperature-controlled during their stay at the pressing element 16. The pressing element 16 consists either entirely of plastic, or is coated with plastic on its bent contact surface 16a to prevent metal abrasion between the cylinder jacket outer surface lla and the contact surface 16a. Teflon can be used as the coating material, for example.

A water container 9 with temperature-controlled water is located under the rotationally driven hollow cylinder 11.

During operation, the viscoelastic fresh cheese mass exits the supply tank 1 and enters the press 2. The viscoelastic mass is there compressed, and pressed into the pressing chamber or packing chamber 3. In the pressing chamber 3, the alveoli 5 of the cylinder jacket outer surface 11a moving past the pressing chamber 3, which forms the moved first inner wall area 3a, are filled by the viscoelastic mass. When the alveoli 5 filled in this manner are moved by a stripping edge or shearing edge 7 formed between the resting second inner wall area 3b and the moving first inner wall area 3a during their movement F, the mass entrained in the alveoli 5 is stripped or sheared away from the rest of the viscoelastic mass filling the pressing chamber 3, and hence “portioned”.

While passing by the pressing element 16, the viscoelastic “portion” of the food mass is located in the completely sealed mold cavity 5* (see also FIG. 2). The enclosed viscoelastic portion can there relax. The relaxation behavior of the viscoelastic mass in the mold cavity 5* can be influenced by adjusting the mold pressure prevailing in the pressing chamber 3, the rotational speed and the controlled temperature of the hollow cylinder 11, as well as the controlled temperature of the pressing element 16. Influence can also be exerted on the relaxation behavior in the mold cavity 5* by adjusting the surface roughness of the contact surface 16a.

FIG. 2 shows more clearly that the dimensional memory is also shaped to a particularly strong extent by the selection of stripping angle or shearing angle α, which is applied between the tangential plane E1 and tangential plane E2. This angle α is preferably smaller than 90°. The smaller this angle in the gusset region Z, the more smoothly (i.e., with less induced tensions in the material_the portions are separated out in the alveoli 5* disappearing under the stripping edge or shearing edge. Even so, tensions always arise in the material while shaping and separating the viscoelastic material, so that warpage always occurs on the molded food articles after shaping is complete.

According to the invention, this warpage is largely compensated by specially shaping the alveoli 5.

FIG. 2 also shows a fluid channel 8 for an alveolus that connects the inner space 15 of the hollow cylinder 11 with the alveolus 5. For simplicity's sake, only one fluid channel 8 is shown here. In actuality, however, all alveoli 5 of the hollow cylinder 11 exhibit such channels 8. Fluid can be passed through these fluid channels 8 via the fluid jet opening s 14 (see FIG. 5, 8) and into the alveolus 5, thereby initiating or supporting the shaping process.

FIG. 3A and FIG. 3B show one especially illustrative example for the compensation according to the invention of warpage that arises after shaping. FIG. 3A is a top view of a viscoelastic food article, and FIG. 3B is a top view of an alveolus according to the invention for manufacturing the food article shown on FIG. 3A as described in the invention.

The arrow F shows the motional direction of the cylinder jacket outer surface 11a (see FIG. 1 or FIG. 2). If the cylinder jacket outer surface 11a moves downward with the cross-shaped alveolus 5 contained therein on the figure, it means that the stripping edge or shearing edge 7 (see FIG. 1 or FIG. 2) in the figure is moving upward. This means that the shearing edge 7 on FIG. 3B moves from point P1 to point P2, running along the edge of the alveolus 5 filled with the viscoelastic mass in the process. It has been shown that warpage can be largely compensated after deforming by stretching the cavity of the alveolus 5 relative to the shape complementary to the food article 10 to be manufactured. To this end, the shape of the alveolus cavity that complements the shape of the food article 10 is stretched by a stretching factor S parallel to the motional direction F. In other words, the inner dimensions a and b of the mold complementary to the shape of the food article 10 (not shown) are replaced by the somewhat greater dimensions a′ and b′, wherein S=a′/a=b′/b.

Therefore, warpage compensation can be optimized first and foremost by adjusting the stretching factor S and angle α.

Further optimization can be achieved by setting the mold pressure prevailing in the pressing chamber 3, and by temperature controlling the hollow cylinder 11 and, if necessary, temperature-controlling the pressing element 16.

Therefore, the device according to the invention permits a “fixed “optimization via the optimal selection and adjustment of the stretching factor S and stripping angle α on the one hand, along with a “variable” optimization during the process according to the invention by setting the rotational speed of the hollow cylinder 11, the mold pressure in the pressing chamber 3, and, if necessary, by adjusting the temperature controller for the alveoli 5*.

However, the deviation of the instantaneously formed food articles 10 from the desired shape or target shape can also be determined, to then take corresponding measures for the operationally variable parameters, such as speed of hollow cylinder 11, shearing angle α, “spatial temperature profile” (temperature control on hollow cylinder 11 before shaping) or “temperature profile over time” (water temperatures in water containers, which serially carry the molded food articles).

FIGS. 4 and 5 are three-dimensional views of a first example for a hollow cylinder 11 according to the invention with heart-shaped alveoli 5 in the cylinder jacket outer surface 11a. Also visible are fluid jet openings 14 in the middle of each alveolus 5. Water and/or air from the inner area 15 of the rotationally driven hollow cylinder 11 can be introduced through these fluid jet openings 14 via fluid channels 8 (see FIG. 2) into the alveoli 5 filled with the shaped food articles. This makes it possible to support the shaping process on the one hand, and also to implement temperature control (temperature shock for increasing dimensional stability).

FIGS. 6, 7 and 8 are three-dimensional views of a second example for a hollow cylinder 11 according to the invention with cross-shaped alveoli 5 in the cylinder jacket outer surface 11a. Also visible here are the fluid jet openings 14 in the middle of each alveolus 5. Here as well, water and/or air can be from the inner area 15 of the rotationally driven hollow cylinder 11 can be introduced through these fluid jet openings 14 via fluid channels 8 (see FIG. 2) into the alveoli 5 filled with the shaped food articles.

Similarly to the diagrammatic view on FIG. 3B, FIG. 8 shows the dimensions parallel to the motional direction F elongated by a stretching factor S.

FIG. 9 is a diagrammatic view of a longitudinal section of the hollow cylinder 11 along the cylindrical axis 12, as well as a winding of its cylinder jacket outer surface 11a with heart-shaped alveoli 5 according to FIG. 4.

FIG. 10 is a diagrammatic view of a longitudinal section of the hollow cylinder 11 along the cylinder axis 12, as well as a winding of its cylinder jacket outer surface 11a with cross-shaped alveoli according to FIG. 6.

### REFERENCE LIST

1 Supply tank
2 Press
2a Press input
2b Press output
3 Pressing chamber or packing chamber
3a First inner wall area
3b Second inner wall area
4 Sealing surface
5 Depression or alveolus
5* Closed mold cavity
6 Alveolus surface
7 Stripping edge or shearing edge
8 Shaping means or fluid channel
9 Water container
10 Fresh cheese articles
11 Cylindrical blow molding, rotationally driven
11a Cylinder jacket outer surface
11b Cylinder jacket inner surface
12 Cylinder axis or rotational axis
13 Resting blow molding
14 Fluid jet opening
15 Inner space
16 Pressing element
16a Contact surface
E1 Tangential plane of alveolus surface (first inner wall area 3a)
E2 Tangential plane of shearing surface (second inner wall area 3b)
F Motional direction
M Drive unit
S Stretching factor of alveolus along the motional direction
Z Gusset surface
αStripping angle or shearing angle

1. A device for manufacturing molded, viscoelastic food articles, in particular out of doughy, viscoelastic fresh cheese, such as mozzarella or mascarpone, with:
A supply tank for the viscoelastic food as the initial mass;
A pressing chamber or packing chamber, the inner wall of which exhibits a first inner wall area and a second inner wall area, which contact each other tightly at a sealing surface, wherein the first inner wall area can move relative to the second inner wall area, and the two inner wall areas come into tight contact during their relative movement along the sealing surface or contacting edge;
Depressions or alveoli in the alveoli surface of the first inner wall area pointing into the pressing chamber, which act as a mold cavity;
A press, the input of which is connected with the supply tank I and the output of which is connected with the pressing chamber;
A stripping edge or shearing edge, which abuts the alveoli surface of the first inner wall area pointing into the pressing chamber, and along which the depressions in the alveoli surface of the first inner wall area pointing into the pressing chamber can move in such a way that the stripping edge or shearing edge extends transverse to the motional direction over the opening of the depression;
A driving means for moving the first inner wall along the stripping edge or shearing edge and removing the depressions from the pressing chamber;
A shaping means for shaping the portions removed from the pressing chamber via discarding and/or ejection from the depressions; and
A water container for collecting the shaped food articles;
characterized in that
the stripping edge or shearing edge is the edge of a stripping surface or shearing surface that points into the pressing chamber, and borders the alveoli surface of the first inner wall area in a gusset area, wherein the tangential plane E2 of the shearing surface forms a shearing angle or stripping angle a of less than 90° with the tangential plane E1 of the alveoli surface in the gusset area; and that
the inner dimensions (a′, b ′) of the mold cavities of the first inner wall area defined by the depressions relative to the inner dimensions (a, b) of the cavity complementary to the shape of the fresh cheese articles to be fabricated are enlarged in the direction parallel to the motional direction of the first inner wall area by a stretching factor S.

2. The device according to claim 1, characterized in that the shearing angle α ranges from 50° to 80°.

3. The device according to claim 2, characterized in that the shearing angle α ranges from 60° to 70°.

4. The device according to claim 1, characterized in that the stretching factor S ranges from 1.05 to 1.5.

5. The device according to claim 4, characterized in that the stretching factor S ranges from 1.1 to 1.3.

6. The device according to claim 1, characterized in that the pressing chamber an be temperature controlled.

7. The device according to claim 6, characterized in that the movable first inner wall area of the pressing chamber an be temperature controlled with a heat carrier fluid.

8. The device according to claim 7, characterized in that the heat carrier fluid is water.

9. The device according to claim 6, characterized in that the movable inner wall area of the pressing chamber can be temperature-controlled to varying along its motional direction.

10. The device according to claim 1, characterized in that the mold pressure or packing pressure that can be generated by the press is adjustable.

11. The device according to claim 1, characterized in that the driving means induced speed at which the alveoli surface moves along the shearing edge is adjustable.

12. The device according to claim 1, characterized in that the movable first inner wall area of the pressing chamber is a partial area of the cylinder jacket outer surface of a cylindrical blow molding, which is rotationally driven around its cylinder axis as the rotational axis, wherein the depressions acting as the mold cavity are situated in the cylinder jacket outer surface.

13. The device according to claim 12,characterized in that the pressing chamber or packing chamber is a resting blow molding, which has an inlet opening fluidically connected with the press, along with an outlet opening, the opening edge of which is designed in such a way that the partial area of the cylinder jacket outer surface pressed against this blow molding outlet opening seals the blow molding outlet opening.

14. The device according to claim 12, characterized in that the depressions are each fluidically connected with the inner space the cylindrical blow molding via a fluid channel that radially traverses the cylinder wall.

15. A method for manufacturing molded and at least partially dimensionally stabilized, viscoelastic food articles, in particular out of a doughy, viscoelastic fresh cheese, such as mozzarella or mascarpone, using the device according to claim 1, wherein the method involves the following steps:
provision of temperature-controlled, viscoelastic food as the initial mass;
Pressing of the viscoelastic initial mass into a pressing chamber, the inner wall of which exhibits a first and second inner wall area, wherein the first inner wall area is moved relative to the second inner wall area, and the two inner wall areas tightly contact each other during the relative movement along a sealing surface or contacting edge, and wherein the first inner wall area exhibits depressions (alveoli) in its surface pointing into the pressing chamber, which act as a mold cavity, so that one portion of the initial mass penetrates into a respective depression owing to the mold pressure, fills it up, and is entrained by it due to the relative movement;
Stripping or shearing of the portions entrained in the depressions from the remaining initial mass volume in the pressing chamber as the depressions of the first inner wall area filled with initial mass portions move past the sealing surface or contacting edge, so that the stripped or sheared portions of the initial mass entrained in the depressions are removed from the pressing chamber;
Shaping of the portions removed from the pressing chamber by discarding and/or ejecting the portions from the depressions into a temperature-controlled water bath;
Retention of the shaped fresh cheese portions in the temperature-controlled water bath.

16. The method according to claim 15 for manufacturing molded and at least partially dimensionally stabilized, viscoelastic food articles, in particular out of mozzarella or mascarpone, characterized in that the temperature-controlled fresh cheese has a temperature ranging from 60° C. to 70° C. while penetrating into the depressions and being removed form the pressing chamber; and that the temperature-controlled water bath has a temperature ranging from 5° C. to 20° C.

17. The method according to claim 16, characterized in that the temperature-controlled water bath exhibits a first water bath with a temperature ranging from 10° C. to 20° C., as well as a second water bath with a temperature ranging from 5° C. to 10° C., in which the shaped portions of fresh cheese can be left to remain sequentially.

18. The method according to claim 16, characterized in that the temperature-controlled fresh cheese has a temperature ranging from 64° C. to 66° C. while penetrating into the depressions and being removed from the pressing chamber.

19. The method according to claim 15, characterized in that the molded fresh cheese portions are shaped by exposing the molded fresh cheese portions sitting in the depressions of the cylinder jacket outer surface to gravitational and/or centrifugal forces.

20. The method according to claim 19 involving the use of the device according to claim 14, characterized in that shaping is supported by a waterjet and/or compressed air, e.g., which is directed into the depressions via the radial fluid channel, and acts on the molded fresh cheese portions sitting in the depressions.

21. The method according to claim 20, characterized in that the water jet and/or compressed air is temperature controlled.
